(19) United States
(12) Patent Application Publication
(10) Pub. No.: US 2026/0313163 A1
(43) Pub. Date: Oct. 8, 2026

(54) DEFAULT AND INFERRED VALUES IN ASPS, AFPS, AND MESHPATCH DATA UNITS IN V-DMC

(71) Applicant: Samsung Electronics Co., Ltd., Suwon-si (KR)

(72) Inventors: Rajan Laxman Joshi, San Diego, CA (US); Madhukar Budagavi, Plano, TX (US)

(21) Appl. No.: 19/576,922

(22) Filed: Mar. 24, 2026

Related U.S. Application Data
(60) Provisional application No. 63/782,998, filed on Apr. 3, 2025.

(51) Int. Cl. H04N 19/597; H04N 19/124; H04N 19/70

(52) U.S. Cl. CPC H04N 19/597; H04N 19/124; H04N 19/70

(57) ABSTRACT

An apparatus includes a communication interface configured to receive a compressed bitstream and a processor operably coupled to the communication interface. The processor is configured to identify one or more flags included in the compressed bitstream each related to a corresponding parameter type. The processor is also configured to determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

### CROSS-REFERENCE TO RELATED APPLICATION AND PRIORITY CLAIM

This application claims priority under 35 U.S.C. § 119 (e) to U.S. Provisional Patent Application No. 63/782,998 filed on Apr. 3, 2025, which is hereby incorporated by reference in its entirety.

### TECHNICAL FIELD

This disclosure relates generally to multimedia devices and processes. More specifically, this disclosure relates to default and inferred values in an atlas sequence parameter set, an atlas frame parameter set, and meshpatch data units.

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for default and inferred values in an atlas sequence parameter set, an atlas frame parameter set, and meshpatch data units.

In one embodiment, an apparatus includes a communication interface configured to receive a compressed bitstream and a processor operably coupled to the communication interface. The processor is configured to identify one or more flags included in the compressed bitstream each related to a corresponding parameter type. The processor is also configured to determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

In another embodiment, a method includes receiving a compressed bitstream. The method also includes identifying one or more flags included in the compressed bitstream each related to a corresponding parameter type. The method also includes determining, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

In yet another embodiment, an apparatus includes a communication interface and a processor operably coupled to the communication interface. The processor is configured to set one or more flags in a compressed bitstream each related to a corresponding parameter type. The processor is also configured to establish, based on the one or more flags, a hierarchy between two or more of an atlas sequence parameter set (ASPS) level, an atlas frame parameter set (AFPS) level, and at least one meshpatch data unit (MDU) level of the compressed bitstream by signaling a copying of parameter values for the corresponding parameter type between one or more of the ASPS level, the AFPS level, and the at least one MDU level and/or signaling an assignment of default parameter values for the corresponding parameter type. The processor is also configured to transmit the compressed bitstream using the communication interface.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example mesh frame encoding process in accordance with this disclosure;

FIG. 5 illustrates an example mesh frame decoding process in accordance with this disclosure;

FIG. 6 illustrates an example default value for inverse quantization offset presence process in accordance with this disclosure;

FIG. 7 illustrates an example meshpatch data unit subdivision process in accordance with this disclosure;

FIG. 8 illustrates an example signaling hierarchy process in accordance with this disclosure;

FIG. 9 illustrates an example encoding method in accordance with this disclosure; and

FIG. 10 illustrates an example decoding method in accordance with this disclosure.

### DETAILED DESCRIPTION

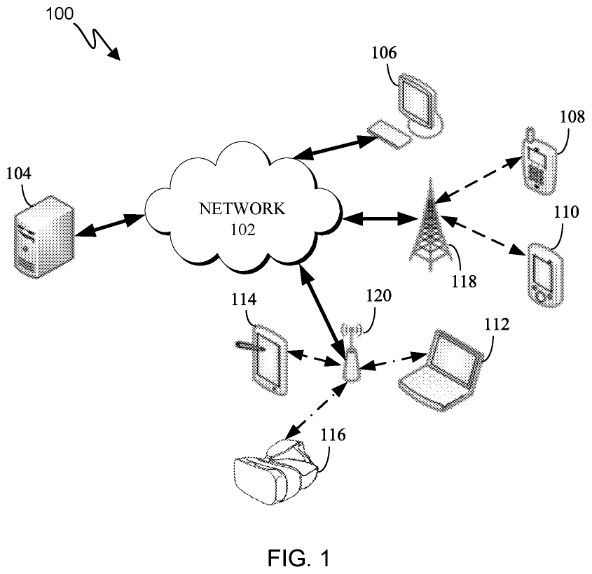

FIGS. 1 through 10, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object's surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally require a large amount of bandwidth for transmission. Due to the large bitrate requirement, point clouds are often compressed prior to transmission. Compressing a 3D object such as a point cloud, often requires specialized hardware. To avoid specialized hardware to compress a 3D point cloud, a 3D point cloud can be transformed into traditional two-dimensional (2D) frames and that can be compressed and later reconstructed and viewable to a user.

Polygonal 3D meshes, especially triangular meshes, are another popular format for representing 3D objects. Meshes typically include a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

As part of an encoding process, a base mesh can be coded using an existing mesh codec, and a reconstructed base mesh can be constructed from the coded original base mesh. The reconstructed base mesh can then be subdivided into one or more subdivided meshes and a displacement field is created for each subdivided mesh.

This disclosure provides for default and inferred values in an atlas sequence parameter set (ASPS), an atlas frame parameter set (AFPS), and meshpatch data units, such as in Video-based Dynamic Mesh Coding (V-DMC).

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 and/or the client devices 106-116 can identify one or more flags included in a compressed bitstream each related to a corresponding parameter type, and determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

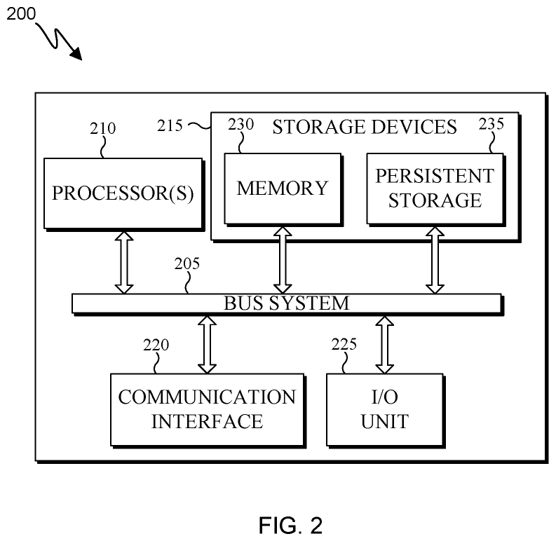

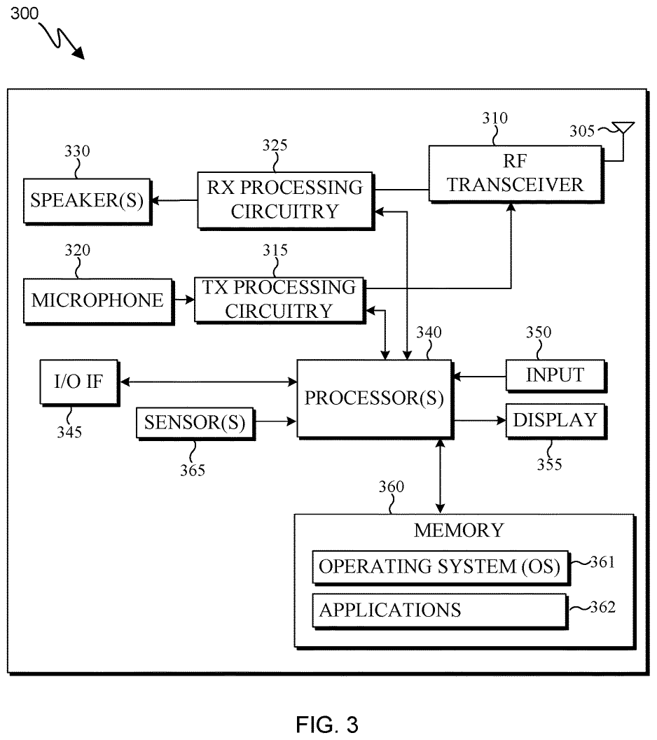

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can identify one or more flags included in a compressed bitstream each related to a corresponding parameter type, and determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

In certain embodiments, the processor 340 can identify one or more flags included in a compressed bitstream each related to a corresponding parameter type, and determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

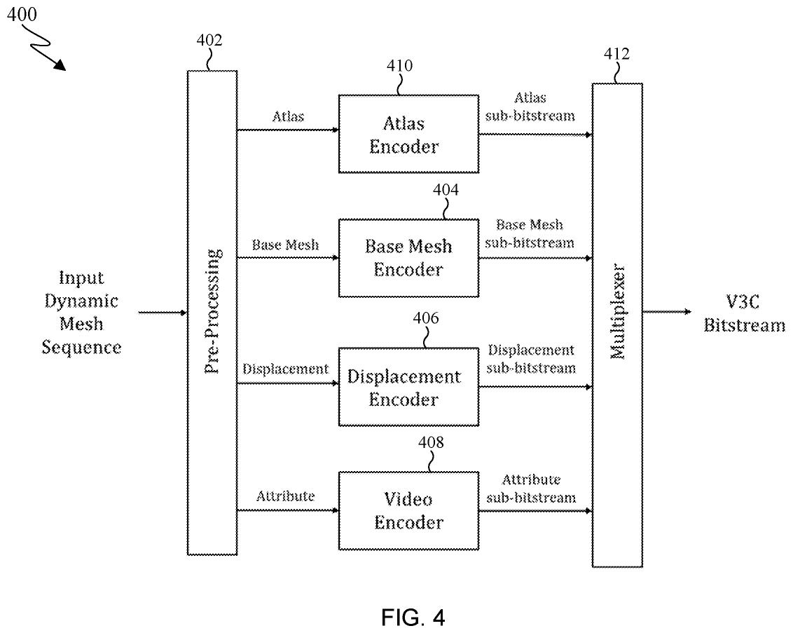

FIG. 4 illustrates an example encoding process 400 in accordance with this disclosure. The encoding process 400 illustrated in FIG. 4 is for illustration only. FIG. 4 does not limit the scope of this disclosure to any particular implementation of an encoding process. For ease of explanation, the process 400 of FIG. 4 may be described as being performed using the electronic device 300 of FIG. 3. However, the process 400 may be used with any other suitable system and any other suitable electronic device.

As shown in FIG. 4, the encoding process 400 performs pre-processing 402 on a dynamic mesh sequence using an encoder. The encoder can be represented by, or executed by, the server 200 shown in FIG. 2 or the electronic device 300 shown in FIG. 3. A base mesh, which typically has a smaller number of vertices compared to the original base mesh, is created via the pre-processing 402. A base mesh encoder 404 is used to quantize and compress the base mesh in either a lossy or lossless manner, and the base mesh is encoded as a compressed base mesh sub-bitstream. The base mesh can be intra coded (no prediction from neighboring base mesh frames) or inter coded (predicted from neighboring base mesh frames).

The base mesh can then be reconstructed, providing a reconstructed base mesh. This reconstructed base mesh then undergoes one or more levels of subdivision and a displacement field is created by a displacement encoder 406 for each subdivision representing the difference between the original mesh and the subdivided reconstructed base mesh. In inter-coding of a mesh frame, the base mesh is coded by sending vertex motions instead of compressing the base mesh directly. In either case, a displacement field is created. Each displacement of the displacement field has three components, denoted by x, y, and z. These may be with respect to a canonical coordinate system or a local coordinate system where x, y, and z represent the displacement in local normal, tangent, and bi-tangent directions. As shown in FIG. 4, a displacement sub-bitstream is provided by the displacement encoder 406.

As also shown in FIG. 4, an attribute transfer operation can be performed using an video encoder 408. The video encoder 408 can use a deformed mesh, a static/dynamic mesh, and an attribute map to create an attribute sub-bitstream. A point cloud is a set of 3D points along with attributes such as color, normals, reflectivity, point-size, etc. that represent an object's surface or volume. These attributes are encoded as a compressed attribute bitstream. The encoding of the compressed attribute sub-bitstream may also include a padding operation, a color space conversion operation, and a video encoding operation. In various embodiments, an atlas can also be encoded as a compressed atlas sub-bitstream using an atlas encoder 410. The atlas component provides information to a decoding and/or rendering system on how to perform inverse reconstruction. For example, the atlas can provide information on how to perform the subdivision of a base mesh, how to apply the displacement vectors to the subdivided mesh vertices, and how to apply attributes to the reconstructed mesh.

Each of the sub-bitstreams are provided to a multiplexer 412. The multiplexer 412 multiplexes the sub-bitstreams and outputs a compressed bitstream (e.g., a Visual Volumetric Video-based Coding (V3C) bitstream) that can, for example, be transmitted to, and decoded by, an electronic device such as the server 104 or the client devices 106-116. As shown in FIG. 4, the output compressed bitstream can include the compressed atlas bitstream, the compressed base mesh bitstream, the compressed displacements bitstream, and the compressed attribute bitstream as sub-bitstreams of the compressed bitstream.

Although FIG. 4 illustrates one example encoding process 400, various changes may be made to FIG. 4. For example, the number and placement of various components of the encoding process 400 can vary as needed or desired. In addition, the encoding process 400 may be used in any other suitable process and is not limited to the specific processes described above.

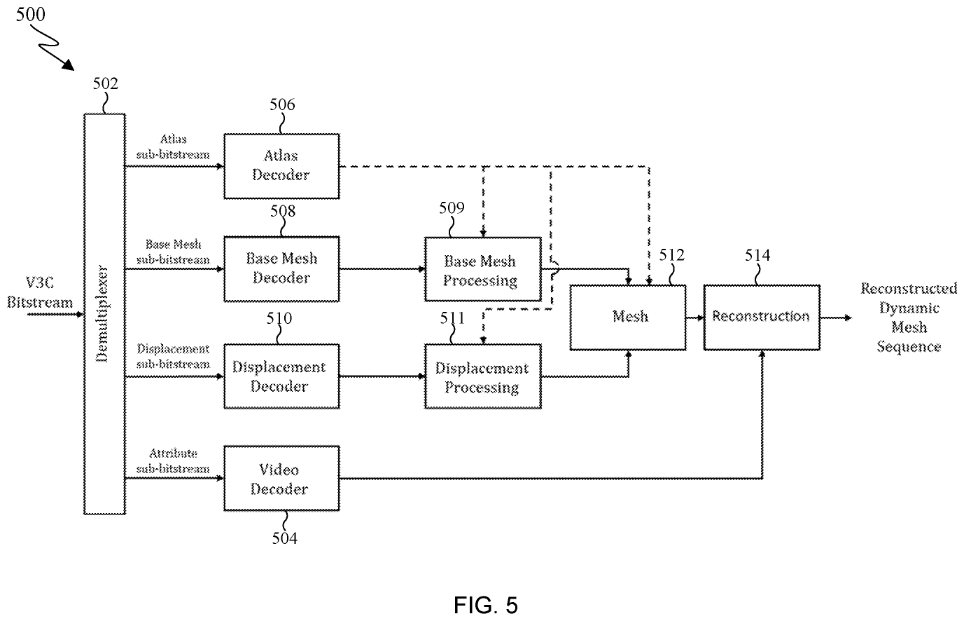

FIG. 5 illustrates an example mesh frame decoding process 500 in accordance with this disclosure. The decoding process 500 illustrated in FIG. 5 is for illustration only. FIG. 5 does not limit the scope of this disclosure to any particular implementation of a mesh frame decoding process. For ease of explanation, the process 500 of FIG. 5 may be described as being performed using the electronic device 300 of FIG. 3. However, the process 500 may be used with any other suitable system and any other suitable electronic device.

The decoding process 500 involves a demultiplexer 502 of a decoder that receives an incoming bitstream, e.g., the bitstream output by the encoder of the process 400 of FIG. 4. The demultiplexer 502 separates out the various component sub-bitstreams from the incoming bitstream, including the compressed base mesh sub-bitstream, the compressed displacement sub-bitstream, the compressed attribute sub-bitstream, and the atlas sub-bitstream, such as described with respect to FIG. 4. The compressed attribute sub-bitstream is decoded using a video decoder 504, the decoded attributes are processed using a color space conversion operation, and the original attributes for the mesh are recovered. The decoding process also can include processing the atlas sub-bitstream using an atlas decoder 506 to obtain the atlas data for the base mesh. The atlas sub-bitstream can be decoded to obtain an atlas that provides information on how to perform inverse reconstruction. For example, the atlas can provide information on how to perform the subdivision of a base mesh, how to apply the displacement vectors to the subdivided mesh vertices, and how to apply attributes to the reconstructed mesh.

The decoding process 500 also includes processing the base mesh sub-stream using a base mesh decoder 508. The base mesh decoder 508 decodes the base mesh sub-bitstream to form a reconstructed base mesh 512. A base mesh processing operation 509 subdivides the reconstructed base mesh and a displacement processing operation 511 extracts the displacement field from the decoded displacements. Then, the two are added together to form a reconstructed mesh. Particularly, the decoding process 500 includes decoding the displacements sub-bitstream using a displacement decoder 510, which can, in some embodiments, be the same decoder as the video decoder 504. The decoded displacements data can undergo an image unpacking operation, an inverse quantization operation, and an inverse wavelet transform operation, as part of recovering the positions displacements data. Recovering the positions displacements data can also include performing using displacement processing operation 511 on the mesh frames recovered using a base mesh decoder 508, and extracting x, y, z components (normal, tangent, bitangent) from the subdivided mesh frames. The received displacement field is decompressed and added to the subdivided reconstructed base mesh 512 as part of a reconstruction operation 514 to generate a final reconstructed mesh in the decoder, e.g., the reconstructed dynamic mesh sequence shown in FIG. 5.

Although FIG. 5 illustrates one example frame decoding process 500, various changes may be made to FIG. 5. For example, the number and placement of various components of the decoding process 500 can vary as needed or desired. In addition, the decoding process 500 may be used in any other suitable process and is not limited to the specific processes described above. Also, while shown as a series of steps, various steps in FIG. 5 may overlap, occur in parallel, or occur any number of times.

Various standards have been proposed with respect to vertex mesh and dynamic mesh coding. The following documents are hereby incorporated by reference in their entirety as if fully set forth herein:
“V-DMC TMM v11, ISO/IEC SC29 WG07 N01095, March 2025.
“Text of ISO/IEC DIS 23090-29 Video-based mesh coding”, ISO/IEC SC29 WG07 N01027, December 2024.
“Technologies for Video-based mesh coding”, ISO/IEC SC29 WG07 N01099, February 2025.

This disclosure provides various ways in which mesh coding is improved. Throughout this disclosure, changes to the existing coding elements are shown inside bolded double brackets ([[ ]]) to show deletions. Additions are shown inside bolded double dashes (-- --).

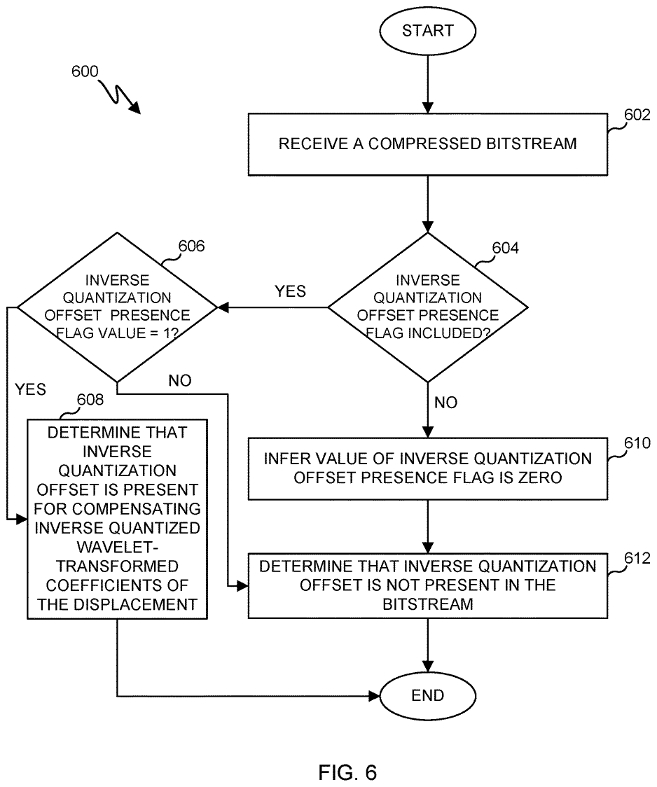

FIG. 6 illustrates an example default value for inverse quantization offset presence process 600 in accordance with this disclosure. The process 600 illustrated in FIG. 6 is for illustration only. FIG. 6 does not limit the scope of this disclosure to any particular implementation of a default value for inverse quantization offset presence process. For ease of explanation, the process 600 of FIG. 6 may be described as being performed using the electronic device 300 of FIG. 3. However, the process 600 may be used with any other suitable system and any other suitable electronic device.

In various embodiments of this disclosure, a missing default value is used for an inverse quantization offset presence flag syntax element for atlas sequence V-DMC extensions (ASVE) (e.g., “asve_inverse_quantization_offset_present_flag”) when the ASVE inverse quantization offset presence flag syntax element is not present in the bitstream. In previous implementations, when the ASVE inverse quantization offset presence flag syntax element was not present in the bitstream, it would be unclear what value should be inferred or assigned to it. This could cause a decoder to experience unexpected behaviors.

As shown in FIG. 6, to solve this problem, this disclosure provides that, when the ASVE inverse quantization offset presence flag syntax element for ASVE (e.g., “asve_inverse_quantization_offset_present_flag”) is not present in the bitstream, this syntax element is inferred to have a value of 0.

At step 602, a compressed bitstream is received. At step 604, it is determined whether the ASVE inverse quantization offset presence flag syntax element is included in the bitstream. If so, at step 606, it is determined if the ASVE inverse quantization offset presence flag is set to a value of 1. If the ASVE inverse quantization offset presence flag is set to a value of 1, at step 608, it is determined that the inverse quantization offset is present for compensating inverse quantized wavelet-transformed coefficients of a displacement associated with a mesh. If, on the other hand, the ASVE inverse quantization offset presence flag is set to a value of 0, at step 612, it is determined that the inverse quantization offset is not present in the bitstream.

If, at step 604, it is determined that the ASVE inverse quantization offset presence flag is absent from the bitstream. Then, it is inferred, at step 610, that the value of the ASVE inverse quantization offset presence flag is 0. Then, accordingly, at step 612, it is determined that the inverse quantization offset is not present in the bitstream.

Corresponding semantics for this new inference based on the absence of the ASVE inverse quantization offset presence flag are as follows:

### 8.4.6.1.3 Atlas Sequence Parameter Set V-DMC Extension Semantics

asve_inverse_quantization_offset_present_flag equal to 1 specifies that the inverse quantization offset is present for compensating the inverse quantized wavelet-transformed coefficients of the displacement. asve_inverse_quantization_offset_present_flag equal to 0 specifies that the inverse quantization offset is not present.--When not present, the value of asve_inverse_quantization_offset_present_flag is inferred to be 0.
AspsInvQuantOffsetPresentFlag=asve_inverse_quantization_offset_present_flag
asve_transform_method indicates the identifier of the transform applied to the displacement. describes the list of supported transforms and their relationship with asve_transform_method. When not present asve_transform_method is inferred to be equal to 0.

Although FIG. 6 illustrates one example of a default value for inverse quantization offset presence process 600, various changes may be made to FIG. 6. For example, the process 600 may be used in any other suitable process and is not limited to the specific processes described above. Also, while shown as a series of steps, various steps in FIG. 6 may overlap, occur in parallel, or occur any number of times.

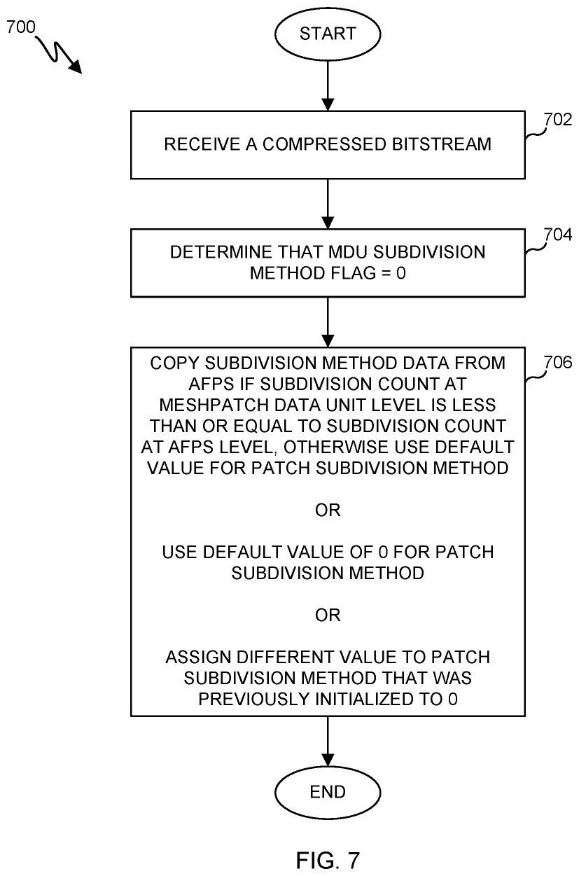

FIG. 7 illustrates an example meshpatch data unit subdivision process 700 in accordance with this disclosure. The process 700 illustrated in FIG. 7 is for illustration only. FIG. 7 does not limit the scope of this disclosure to any particular implementation of a meshpatch data unit subdivision process. For ease of explanation, the process 700 of FIG. 7 may be described as being performed using the electronic device 300 of FIG. 3. However, the process 700 may be used with any other suitable system and any other suitable electronic device.

Various embodiments of this disclosure relate to signaling certain additional syntax elements in atlas sequence parameter set (ASPS) and atlas frame parameter set (AFPS), and copying values for certain variables and syntax elements from ASPS to AFPS and meshpatch data units (MDUs).

In prior implementations, in the meshpatch data unit, when an MDU subdivision method present flag (e.g., “mdu_subdivision_method_present_flag[tileID][patchIdx]”) was equal to 0, the subdivision method for different levels of displacement (LODs) would be set to be equal to the corresponding subdivision method from the AFPS. However, there is no guarantee that the number of subdivision levels in the meshpatch and the AFPS are the same.

As shown in FIG. 7, at step 702, a compressed bitstream is received. At step 704, it is determined that the MDU subdivision method flag is equal to 0. In such a case, as shown in step 706 of FIG. 7, various embodiments of this disclosure provide for a means to deal with a situation where the MDU subdivision flag is set to 0 that avoids the issue noted above of the number of subdivision levels in the meshpatch and the AFPS possibly being different.

In some embodiments, this disclosure provides that the copying of the subdivision method from the AFPS is performed only when the number of subdivisions at the meshpatch unit level is less than or equal to the number of subdivisions at the AFPS level. That is, a condition is added that the subdivision count at the meshpatch data unit level is less than or equal to the subdivision count at the AFPS level to copy subdivision method data. Otherwise, the default value for subdivision method is used.

Related syntax, semantics and processes are as follows in Table 1.

### 8.3.9.3 Meshpatch Data Unit Syntax

TABLE 1

| | Descriptor |
|---|---|
| meshpatch_data_unit( tileID, patchIdx ) { | |
| ... | ue(v) |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method [ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| } else --if (PatchSubdivisionCount[ tileID ][ patchIdx ] < = | |
| AfpsSubdivisionCount)-- { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| --} else { | |
| for( i = 0; i < PatchSubdivisionCount[ tileID ][ patchIdx ]; i++ ) | |
| PatchSubdivisionMethod[ tileID ][ patchIdx ][ i ] = 0-- | |
| } | |
| if( asve_edge_based_subdivision_flag == 1 ) { | |
| ... | |
| } | |

### Corresponding Semantics are as Follows:

### 8.4.9.3 Meshpatch Data Unit Semantics

mdu_subdivision_method[tileID][patchIdx][i] indicates the identifier of the method to subdivide the subparts of the mesh associated with a meshpatch with index patchIdx, in the current atlas tile, with tile ID equal to tileID at the subdivision with subdivision index equal to i. [[When mdu_subdivision_method[tileID][patchIdx][i] is not present, its value is inferred to be equal to afve_subdivision_method[i].]]

As also shown in FIG. 7, in some embodiments, instead of copying values from “AfpsSubdivisionMethod,” a default value of 0 is used for the patch subdivision method.

Related syntax, semantics and processes are as follows in Table 2.

### 8.3.9.4 Meshpatch Data Unit Syntax

TABLE 2

| | Descriptor |
|---|---|
| meshpatch_data_unit( tileID, patchIdx ) { | |
| ... | ue(v) |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| } else { | |
| for( i = 0; i < PatchSubdivisionCount[ tileID ][ patchIdx ]; i++ ){ | |
| PatchSubdivisionMethod[ tileID ][ patchIdx ][ i ] = --0-- | |
| [[AfpsSubdivisionMethod[ i ] ]] | |
| } | |
| } | |
| if( asve_edge_based_subdivision_flag == 1 ) { | |
| ... | |
| } | |

### Corresponding Semantics are as Follows:

### 8.4.9.3 Meshpatch Data Unit Semantics

mdu_subdivision_method[tileID][patchIdx][i] indicates the identifier of the method to subdivide the subparts of the mesh associated with a meshpatch with index patchIdx, in the current atlas tile, with tile ID equal to tileID at the subdivision with subdivision index equal to i. [[When mdu_subdivision_method[tileID][patchIdx][i] is not present, its value is inferred to be equal to afve_subdivision_method[i].]]

As also shown in FIG. 7, in some embodiments, the “PatchSubdivisionMethod” variable is initialized to 0 and it is assigned a different value only when the value of the “mdu_subdivision_method_present_flag[tileID][patchIdx]” is equal to 0. In this case, the original else clause shown below can be eliminated. Related syntax, semantics and processes are as follows in Table 3.

### 8.3.9.5 Meshpatch Data Unit Syntax

TABLE 3

| | Descriptor |
|---|---|
| meshpatch_data_unit( tileID, patchIdx ) { | |
| ... | ue(v) |
| if( mdu_subdivision_method_present_flag[ tileID ][ patchIdx ] ){ | |
| if( PatchSubdivisionCount[ tileID ][ patchIdx ] > 1) { | |
| mdu_lod_adaptive_subdivision_flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_subdivision_method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| [[} else { | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } ]] | |
| } | |
| if( asve_edge_based_subdivision_flag == 1 ) { | |
| ... | |
| } | |

Although FIG. 7 illustrates one example of a meshpatch data unit subdivision process 700, various changes may be made to FIG. 7. For example, the process 700 may be used in any other suitable process and is not limited to the specific processes described above. Also, while shown as a series of steps, various steps in FIG. 7 may overlap, occur in parallel, or occur any number of times.

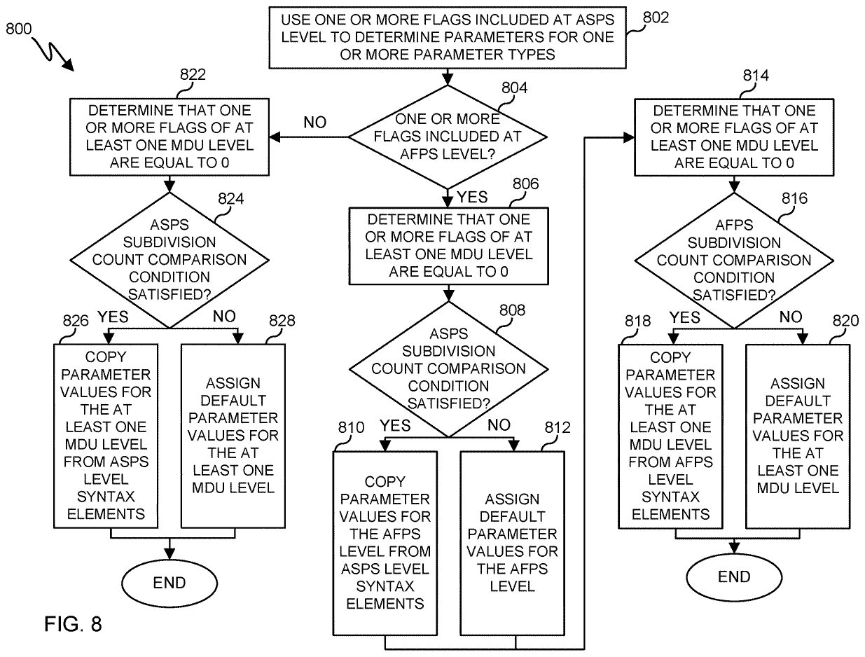

FIG. 8 illustrates an example signaling hierarchy process 800 in accordance with this disclosure. The process 800 illustrated in FIG. 8 is for illustration only. FIG. 8 does not limit the scope of this disclosure to any particular implementation of signaling hierarchy process. For ease of explanation, the process 800 of FIG. 8 may be described as being performed using the electronic device 300 of FIG. 3. However, the process 700 may be used with any other suitable system and any other suitable electronic device.

For certain syntax elements, e.g. subdivision iteration count, subdivision method, etc., there is a hierarchy of signaling. For example, “asve_subdivision_iteration_count” is signaled in the ASPS. This can be overridden by an “afve_subdivision_iteration_count” element in the AFPS. This can, in turn, be overridden by an “mdu_subdivision_iteration_count” element in the meshpatch data unit. A similar principle holds true for the “asve_subdivision_method,” the “afve_subdivision_method,” and the “mdu_subdivision_method.” However, this design in existing implementations is not consistent.

For example, ASPS contains flags asve_inverse_quantization_offset_present_flag, asve_lifting_offset_present_flag, and asve_directional_lifting present_flag to indicate the presence of inverse quantization offsets, lifting offsets, and directional lifting parameters, respectively. However, even when these flags have a value of 1, no additional parameters are signaled in the ASPS. The inverse quantization offsets, lifting offsets, and directional lifting related parameters can only be signaled at the meshpatch data unit level (intra, inter or merge). Also, there are no corresponding flags at the AFPS level.

To have a consistent design and to have the ability to signal a single set of parameters for the whole sequence or at the frame level, this disclosure provides for creating a hierarchy between ASPS, AFPS, and the meshpatch data unit for inverse quantization offsets, lifting offsets, and directional lifting related parameters.

In some embodiments, such as shown at step 802, one or more flags (e.g., (“asve_inverse_quantization_offset_present_flag”, “asve_lifting_offset_present_flag”, and/or “asve_directional_lifting_present_flag”), included at asps level are used to determine parameters for one or more parameter types. These parameter types can include inverse quantization offset parameters, lifting offset parameters, and directional lifting parameters. For example, for inverse quantization offset parameters, when the “asve_inverse_quantization_offset_present_flag” has a value equal to 1, additional syntax elements are signaled in at the ASPS level relating to inverse quantization offset parameters.

Related syntax, semantics and processes are as follows in Table 4.

### 8.3.6.1.3 Atlas Sequence Parameter Set V-DMC Extension Syntax

TABLE 4

| | Descriptor |
|---|---|
| asps_vdmc_extension( ) { | |
| ... | |
| asve_quantization_parameters_present_flag | u(1) |
| if( asve_quantization_parameters_present_flag ) { | |
| asve_inverse_quantization_offset_present_flag | u(1) |
| --if (asve_inverse_quantization_offset_present_flag) { | |
| for( i = 0; i < AspsSubdivisionCount + 1; i++ ) { | |
| for( j = 0; j < AspsDispComponents; j++ ) { | |
| for( k = 0; k < 3; k++ ) { | |
| asve_inverse_quantization_offset_sign[ i ][ j ][ k ] | u(1) |
| asve_inverse_quantization_offset_value_log2_prec1_delta[ i ][ j ][ k ] | se(v) |
| asve_inverse_quantization_offset_value_log2_prec2_delta [ i ][ j ][ k ] | se(v) |
| } | |
| } | |
| } | |
| }-- | |
| vdmc_quantization_parameters( 0, AspsSubdivisionCount, 0) | |
| } | |
| ... | |
| } | |

### Corresponding Semantics are as Follows:

### 8.4.6.1.3 Atlas Sequence Parameter Set V-DMC Extension Semantics

asve_inverse_quantization_offset_present_flag equal to 1 specifies that the inverse quantization offset is present for compensating the inverse quantized wavelet-transformed coefficients of the displacement. asve_inverse_quantization_offset_present_flag equal to 0 specifies that the inverse quantization offset is not present.
AspsInvQuantOffsetPresentFlag=asve_inverse_quantization_offset_present_flag
asve_inverse_quantization_offset_sign[i][j][k] indicates the sign of the inverse quantization offset value which is used for compensating the inverse quantized wavelet-transformed displacement coefficients, located in zone k, with displacement dimension j, LoD i. When not present, the value of asve_inverse_quantization_offset_sign[i][j][k] is inferred to be equal to 0.
asve_inverse_quantization_offset_value_log2_prec1_delta[i][j][k] indicates difference of the values of the inverse quantization offset value for a first precision level located in zone k, with displacement dimension j, between LoD i and LoD i-1 when i is non-zero value. When i is zero, it indicates the absolute value for the offset value for a first precision level associated with LoD 0. When not present, asve_inverse_quantization_offset_value_log2_prec1_delta[i][j][k] is inferred to be equal to 0.
asve_inverse_quantization_offset_value_log2_prec2_delta[i][j][k] indicates the value of the inverse quantization offset value for a second precision level located in zone k, with displacement dimension j, between LoD i and LoD i-1 when i is non-zero value. When i is zero, it indicates the absolute value for the offset value for a second precision level associated with LoD 0. When not present, asve_inverse_quantization_offset_value_log2_prec2_delta[i][j][k] is inferred to be equal to 0.

In some embodiments, such as shown at step 804, a new syntax element can be used at the AFPS level for the different parameters, such as a “afve_inverse_quantization_offset_present_flag” for inverse quantization offset parameters, “afve_lifting_offset_present_flag” for lifting offset parameters, and/or “afve_directional_lifting_present_flag”) for directional lifting parameters. If, at step 804, it is determined one or more of these flags are included at the AFPS level, at step 806, it is determined whether the flag(s) is equal to 1. For instance, in the inverse quantization offset example, when “afve_inverse_quantization_offset_present_flag” has a value equal to 1, additional syntax elements are signaled at the AFPS level relating to inverse quantization offset parameters. Otherwise, when the value is 0, either the values are copied from the corresponding ASPS level syntax elements at step 810 or assigned default values at step 812, based on a determination at step 808 in which it is determined whether an AFPS subdivision count is less than or equal to an ASPS subdivision count (or whether the subdivision counts are equal in some embodiments).

Related syntax, semantics and processes are as follows in Table 5.

### 8.3.6.2.3 Atlas Frame Parameter Set V-DMC Extension Syntax

TABLE 5

| | Descriptor |
|---|---|
| afps_vdmc_extension( ) { | |
| ... | |
| } else | |
| AfpsSubdivisionMinEdgeLength = 0 | |
| if( afve_quantization_parameters_present_flag ) { | |
| --afve_inverse_quantization_offset_present_flag | u(1) |
| if( afve_inverse_quantization_offset_present_flag ) { | |
| for( i = 0; i < AfpsSubdivisionCount + 1; i++ ) { | |
| for( j = 0; j < AfpsDispComponents; j++ ) { | |
| for( k = 0; k < 3; k++ ) { | |
| afve_inverse_quantization_offset_sign[ i ][ j ][ k ] | u(1) |
| afve_inverse_quantization_offset_value_log2_prec1_delta[ i ][ j ][ k ] | se(v) |
| afve_inverse_quantization_offset_value_log2_prec2_delta [ i ][ j ][ k ] | se(v) |
| } | |
| } | |
| }-- | |
| --} else if (AfpsSubdivisionCount < = AspsSubdivisionCount) { | |
| afve_inverse_quantization_offset_sign[ i ][ j ][ k ] = | |
| asve_inverse_quantization_offset_sign[ i ][ j ][ k ] | |
| afve_inverse_quantization_offset_value_log2_prec1_delta[ i ][ j ][ k ] = | |
| asve_inverse_quantization_offset_value_log2_prec1_delta[ i ][ j ][ k ] | |
| afve_inverse_quantization_offset_value_log2_prec2_delta[ i ][ j ][ k ] = | |
| asve_inverse_quantization_offset_value_log2_prec2_delta[ i ][ j ][ k ] -- | |
| --else { | |
| afve_inverse_quantization_offset_sign[ i ][ j ][ k ] = 0 | |
| afve_inverse_quantization_offset_value_log2_prec1_delta[ i ][ j ][ k ] = 0 | |
| afve_inverse_quantization_offset_value_log2_prec2_delta[ i ][ j ][ k ] = 0 | |
| }-- | |
| vdmc_quantization_parameters( 1, AfpsSubdivisionCount, AspsSubdivisionCount ) | |
| --}-- | |
| if( afve_transform_method_present_flag && ( AfpsSubdivisionCount != 0 ) ) { | |
| afve_transform_method | u(3) |
| AfpsTransformMethod = afve_transform_method | |
| } | |
| ... | |
| } | |

### Corresponding Semantics are as Follows:

### 8.4.6.2.3 Atlas Frame Parameter Set V-DMC Extension Semantics

afve_subdivision_min_edge_length indicates the value of the threshold of the edge length-based subdivision decision. When afve_subdivision_min_edge_length is not present, afve_subdivision_min_edge_length is equal to asve_subdivision_min_edge_length.
afve_inverse_quantization_offset_present_flag equal to 1 specifies that the inverse quantization offset is present for compensating the inverse quantized wavelet-transformed coefficients of the displacement. afve_inverse_quantization_offset_present_flag equal to 0 specifies that the inverse quantization offset is not present. When not present, the value of
afve_inverse_quantization_offset_present_flag is inferred to be equal to 0.
afve_inverse_quantization_offset_sign[i][j][k] indicates the sign of the inverse quantization offset value which is used for compensating the inverse quantized wavelet-transformed displacement coefficients, located in zone k, with displacement dimension j, LoD i. When not present, the value of afve_inverse_quantization_offset_sign[i][j][k] is inferred to be equal to 0.
afve_inverse_quantization_offset_value_log2_prec1_delta[i][j][k] indicates difference of the values of the inverse quantization offset value for a first precision level located in zone k, with displacement dimension j, between LoD i and LoD i-1 when i is non-zero value. When i is zero, it indicates the absolute value for the offset value for a first precision level associated with LoD 0. When not present, afve_inverse_quantization_offset_value_log2_prec1_delta[i][j][k] is inferred to be equal to 0.
afve_inverse_quantization_offset_value_log2_prec2_delta[i][j][k] indicates the value of the inverse quantization offset value for a second precision level located in zone k, with displacement dimension j, between LoD i and LoD i-1 when i is non-zero value. When i is zero, it indicates the absolute value for the offset value for a second precision level associated with LoD 0. When not present, afve_inverse_quantization_offset_value_log2_prec2_delta[i][j][k] is inferred to be equal to 0.
afve_transform_method indicates the identifier of the transform applied to the displacement. When AfpsSubdivisionCount is equal to 0, afve_transform_method is inferred to be equal to 0. When AfpsSubdivisionCount is not equal to 0 and afve_transform_method is not present, afve_transform_method is inferred to be equal to asve_transform_method. describes the list of supported transforms and their relationship with afve_transform_method.

In some embodiments, the condition shown above in Table 5 of “else if (AfpsSubdivisionCount<=AspsSubdivisionCount)” could be changed to “else if (AfpsSubdivisionCount==AspsSubdivisionCount),” while preserving all the other changes. In this case, if the subdivision count at the AFPS level is equal to the subdivision count at the ASPS level, the syntax elements corresponding to inverse quantization offsets are copied from the ASPS level syntax elements when “afve_inverse_quantization_offset_present_flag” has a value equal to 0.

In some embodiments, as shown at steps 814-820, flags in at least one MDU level (e.g., intra, inter, or merge MDU levels) can be used for the different parameters. For example, these flags can include “mdu_inverse_quantization_offset_enable_flag” for inverse quantization offset parameters, “mdu_lifting_offset_enable_flag” for lifting offset parameters, and/or “mdu_directional_lifting_enable_flag”) for directional lifting parameters. If, at step 814, it is determined one or more of these flags has a value equal to 0, either the values are copied from the corresponding AFPS level syntax elements at step 818 or assigned default values at step 820, based on a determination at step 816 in which it is determined whether an MDU subdivision count is less than or equal to an AFPS subdivision count (or whether the subdivision counts are equal in some embodiments).

For instance, in the quantization offset example, when the value of mdu_inverse_quantization_offset_enable_flag is equal to 0, the inverse quantization offsets in the meshpatch data unit are copied from the corresponding AFPS level syntax elements or assigned default values.

Related syntax, semantics and processes are as follows in Table 6.

### 8.3.9.3 Meshpatch Data Unit Syntax

TABLE 6

| | Descriptor |
|---|---|
| meshpatch_data_unit( tileID, patchIdx ) { | |
| ... | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ k ] | se(v) |
| mdu_inverse_quantization_offset_value_log2_prec2_delta[ tileID ][ patchIdx ][ i ][ j ][ k ] | se(v) |
| } | |
| } | |
| } | |
| --} else if (PatchSubdivisionCount[ tileID ][ patchIdx ] < = | |
| AfpsSubdivisionCount) { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] = | |
| afve_inverse_quantization_offset_sign[ i ][ j ][ k ] | |
| mdu_inverse_quantization_offset_value_log2_prec1_delta[ tileID ][ patchIdx ][ i ][ j ][ k ] = | |
| afve_inverse_quantization_offset_value_log2_prec1_delta[ i ][ j ][ k ] | |
| mdu_inverse_quantization_offset_value_log2_prec2_delta[ tileID ][ patchIdx ][ i ][ j ][ k ] = | |
| afve_inverse_quantization_offset_value_log2_prec2_delta[ i ][ j ][ k ] | |
| } | |
| } | |
| }-- | |
| --} else { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] = 0 | |
| mdu_inverse_quantization_offset_value_log2_prec1_delta[ tileID ][ patchIdx ][ i ][ j ][ k ] = 0 | |
| mdu_inverse_quantization_offset_value_log2_prec2_delta[ tileID ][ patchIdx ][ i ][ j ][ k ] = 0 | |
| } | |
| } | |
| }-- | |
| } | |
| } | |
| mdu_displacement_coordinate_system [ tileID ][ patchIdx ] | u(1) |
| ... | |
| } | |

In some embodiments, when the value of “mdu_inverse_quantization_offset_enable_flag” is equal to 0, the condition for copying inverse quantization offsets is changed from “(PatchSubdivisionCount[tileID][patchIdx]<=AfpsSubdivisionCount)” to “(PatchSubdivisionCount[tileID=patchIdx]==AfpsSubdivisionCount).” The rest of the changes are preserved.

In some embodiments, the ASPS changes introduced earlier in this disclosure are preserved, but the changes introduced in the AFPS are not used. This is shown where, at step 804, it is determined that one or more flags are not included at the AFPS level, and the process 800 moves to step 822. In some embodiments, as shown at steps 822-828, flags in at least one MDU level (e.g., intra, inter, or merge MDU levels) can be used for the different parameters. For example, these flags can include “mdu_inverse_quantization_offset_enable_flag” for inverse quantization offset parameters, “mdu_lifting_offset_enable_flag” for lifting offset parameters, and/or “mdu_directional_lifting_enable_flag”) for directional lifting parameters. If, at step 822, it is determined one or more of these flags has a value equal to 0, either the values are copied from the corresponding ASPS level syntax elements at step 826 or assigned default values at step 828, based on a determination at step 824 in which it is determined whether an MDU subdivision count is less than or equal to an ASPS subdivision count (or whether the subdivision counts are equal in some embodiments).

For instance, in the quantization offset example, when the value of mdu_inverse_quantization_offset_enable_flag is equal to 0, the inverse quantization offsets in the meshpatch data unit are copied from the corresponding ASPS level syntax elements or assigned default values.

Related syntax, semantics and processes are as follows in Tables 7 and 8.

### 8.3.6.1.3 Atlas Sequence Parameter Set V-DMC Extension Syntax

TABLE 7

| | Descriptor |
|---|---|
| asps_vdmc_extension( ) { | |
| ... | |
| asve_quantization_parameters_present_flag | u(1) |
| if( asve_quantization_parameters_present_flag ) { | |
| asve_inverse_quantization_offset_present_flag | u(1) |
| --if (asve_inverse_quantization_offset_present_flag) { | |
| for( i = 0; i < AspsSubdivisionCount + 1; i++ ) { | |
| for( j = 0; j < AspsDispComponents; j++ ) { | |
| for( k = 0; k < 3; k++ ) { | |
| asve_inverse_quantization_offset_sign[ i ][ j ][ k ] | u(1) |
| asve_inverse_quantization_offset_value_log2_prec1_delta[ i ][ j ][ k ] | se(v) |
| asve_inverse_quantization_offset_value_log2_prec2_delta [ i ][ j ][ k ] | se(v) |
| } | |
| } | |
| } | |
| }-- | |
| vdmc_quantization_parameters( 0, AspsSubdivisionCount, 0) | |
| } | |
| ... | |
| } | |

### 8.3.9.4 Meshpatch Data Unit Syntax

TABLE 8

| | Descriptor |
|---|---|
| meshpatch_data_unit( tileID, patchIdx ) { | |
| ... | |
| if( mdu_quantization_present_flag[ tileID ][ patchIdx ] ) | |
| vdmc_quantization_parameters( 2, | |
| PatchSubdivisionCount[ tileID ][ patchIdx ], | |
| AfpsSubdivisionCount ) | |
| if( AspsInvQuantOffsetPresentFlag ) { | |
| mdu_inverse_quantization_offset_enable_flag[ tileID ][ patchIdx ] | u(1) |
| if( mdu_inverse_quantization_offset_enable_flag ) { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] | u(1) |
| mdu_inverse_quantization_offset_value_log2_prec1_delta[ tileID ][ patchIdx ][ i ][ j ][ k ] | se(v) |
| mdu_inverse_quantization_offset_value_log2_prec2_delta[ tileID ][ patchIdx ][ i ][ j ][ k ] | se(v) |
| } | |
| } | |
| } | |
| --} else if (PatchSubdivisionCount[ tileID ][ patchIdx ] < = | |
| AspsSubdivisionCount) { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] = | |
| asve_inverse_quantization_offset_sign[ i ][ j ][ k ] | |
| mdu_inverse_quantization_offset_value_log2_prec1_delta[ tileID ][ patchIdx ][ i ][ j ][ k ] = | |
| asve_inverse_quantization_offset_value_log2_prec1_delta[ i ][ j ][ k ] | |
| mdu_inverse_quantization_offset_value_log2_prec2_delta[ tileID ][ patchIdx ][ i ][ j ][ k ] = | |
| asve_inverse_quantization_offset_value_log2_prec2_delta[ i ][ j ][ k ] | |
| } | |
| } | |
| }-- | |
| --} else { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mdu_inverse_quantization_offset_sign[ tileID ][ patchIdx ][ i ][ j ][ k ] = 0 | |
| mdu_inverse_quantization_offset_value_log2_prec1_delta[ tileID ][ patchIdx ][ i ][ j ][ k ] = 0 | |
| mdu_inverse_quantization_offset_value_log2_prec2_delta[ tileID ][ patchIdx ][ i ][ j ][ k ] = 0 | |
| } | |
| } | |
| }-- | |
| } | |
| } | |
| mdu_displacement_coordinate_system[ tileID ][ patchIdx ] | u(1) |
| ... | |
| } | |

In some embodiments, when the value of mdu_inverse_quantization_offset_enable_flag is equal to 0, the condition for copying inverse quantization offsets is changed from “(PatchSubdivisionCount[tileID][patchIdx]<=AspsSubdivisionCount)” to “(PatchSubdivisionCount[tileID patchIdx]==AspsSubdivisionCount).” The rest of the changes are preserved.

In some embodiments, the changes described in this disclosure for copying inverse quantization offsets when the value of “mdu_inverse_quantization_offset_enable_flag” is equal to 0 are replicated for the merge meshpatch data unit. Here, the changes described in this disclosure to the AFPS level are not used, but the changes described in this disclosure to the ASPS level are still used.

Related syntax, semantics and processes are as follows in Table 9.

### 8.3.9.5 Merge Meshpatch Data Unit Syntax

TABLE 9

| | Descriptor |
|---|---|
| merge_meshpatch_data_unit( tileID, patchIdx ) { | |
| ... | |
| if( AspsInvQuantOffsetPresentFlag ) { | |
| mmdu_inverse_quantization_offset_enable_flag[ tileID ][ patchIdx ] | u(1) |
| if( mmdu_inverse_quantization_offset_enable_flag ) { | |
| for( i = 0; i < MergePatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k] | u(1) |
| mmdu_inverse_quantization_offset_value_log2_prec1_delta[ tileID ][ patchIdx ][ i ][ j ][ k ] | se(v) |
| mmdu_inverse_quantization_offset_value_log2_prec2_delta[ tileID ][ patchIdx ][ i ][ j ][ k ] | se(v) |
| } | |
| } | |
| } | |
| --} else if (PatchSubdivisionCount[ tileID ][ patchIdx ] < = | |
| AspsSubdivisionCount) { | |
| for( i = 0; i < PatchSubdivisionCount[ tileID ][ patchIdx ] + 1; i++ ) { | |
| for( j = 0; j < AspsDispComponents; j++) { | |
| for( k = 0; k < 3; k++ ) { | |
| mmdu_inverse_quantization_offset_sign[ tileID ][ patchIdx ][ i ][ j ][ k ] = | |
| asve_inverse_quantization_offset_sign[ i ][ j ][ k ] | |
| mmdu_inverse_quantization_offset_value_log2_prec1_delta[ tileID ][ patchIdx ][ i ][ j ][ k ] = | |
| asve_inverse_quantization_offset_value_log2_prec1_delta[ i ][ j ][ k ] | |
| mmdu_inverse_quantization_offset_value_log2_prec2_delta[ tileID ][ patchIdx ][ i ][ j ][ k ] = | |
| asve_inverse_quantization_offset_value_log2_prec2_delta[ i ][ j ][ k ] -- | |
| --} else { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| mmdu_inverse_quantization_offset_sign[ tileID ][ patchIdx ][ i ][ j ][ k ] = 0 | |
| mmdu_inverse_quantization_offset_value_log2_prec1_delta[ tileID ][ patchIdx ][ i ][ j ][ k ] = 0 | |
| mmdu_inverse_quantization_offset_value_log2_prec2_delta[ tileID ][ patchIdx ][ i ][ j ][ k ] = 0 | |
| } | |
| }-- | |
| } | |
| } | |
| if( AspsLiftingOffsetPresentFlag){ | |
| ... | |
| } | |

In some embodiments, the changes described in this disclosure for copying inverse quantization offsets when the value of “mdu_inverse_quantization_offset_enable_flag” is equal to 0 are replicated for the inter meshpatch data unit. Here, the changes described in this disclosure to the AFPS level are not used, but the changes described in this disclosure to the ASPS level are still used.

Related syntax, semantics and processes are as follows in Table 10.

### 8.3.9.6 Inter Meshpatch Data Unit Syntax

TABLE 10

| | Descriptor |
|---|---|
| inter_meshpatch_data_unit( tileID, patchIdx ) { | |
| ... | |
| if( AspsInvQuantOffsetPresentFlag ) { | |
| imdu_inverse_quantization_offset_enable_flag[ tileID ][ patchIdx ] | u(1) |
| if( imdu_inverse_quantization_offset_enable_flag ) { | |
| for( i = 0; i < InterPatchSubdivisionCount[ tileID ][ patchIdx ] + 1; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k] | u(1) |
| imdu_inverse_quantization_offset_value_log2_prec1_delta[ tileID ][ patchIdx ][ i ][ j ][ k ] | se(v) |
| imdu_inverse_quantization_offset_value_log2_prec2_delta[ tileID ][ patchIdx ][ i ][ j ][ k ] | se(v) |
| } | |
| } | |
| } | |
| --} else if (PatchSubdivisionCount[ tileID ][ patchIdx ] < = | |
| AspsSubdivisionCount) { | |
| for( i = 0; i < PatchSubdivisionCount[ tileID ][ patchIdx ] + 1; i++ ) { | |
| for( j = 0; j < AspsDispComponents; j++ ) { | |
| for( k = 0; k < 3; k++ ) { | |
| imdu_inverse_quantization_offset_sign[ tileID ][ patchIdx ][ i ][ j ][ k ] = | u(1) |
| asve_inverse_quantization_offset_sign[ i ][ j ][ k ] | |
| imdu_inverse_quantization_offset_value_log2_prec1_delta[ tileID ][ patchIdx ][ i ][ j ][ k ] = | u(1) |
| asve_inverse_quantization_offset_value_log2_prec1_delta[ i ][ j ][ k ] | |
| imdu_inverse_quantization_offset_value_log2_prec2_delta[ tileID ][ patchIdx ][ i ][ j ][ k ] = | |
| asve_inverse_quantization_offset_value_log2_prec2_delta[ i ][ j ][ k ] -- | |
| --} else { | u(3) |
| for( i = 0; i < PatchSubdivisionCount[ tileID ][ patchIdx ] + 1; i++ ) { | |
| for( j = 0; j < AspsDispComponents; j++) { | |
| for( k = 0; k < 3; k++ ) { | |
| imdu_inverse_quantization_offset_sign[ tileID ][ patchIdx ][ i ][ j ][ k ] = 0 | |
| imdu_inverse_quantization_offset_value_log2_prec1_delta[ tileID ][ patchIdx ][ i ][ j ][ k ] = 0 | |
| imdu_inverse_quantization_offset_value_log2_prec2_delta[ tileID ][ patchIdx ][ i ][ j ][ k ] = 0 | |
| } | |
| } | |
| }-- | |
| } | |
| if( InterPatchSubdivisionCount[ tileID ][ patchIdx ] != 0 ) | |
| ... | |
| } | |

In some embodiments, a similar hierarchy as described in the various embodiments above can be created between ASPS, AFPS, and the intra meshpatch data unit for signaling of lifting offsets. In some embodiments, a similar hierarchy as described in the various embodiments above can also be created between ASPS, AFPS, and the intra meshpatch data unit for signaling of directional lifting parameters.

Although FIG. 8 illustrates one example of a signaling hierarchy process 800, various changes may be made to FIG. 8. For example, the process 800 may be used in any other suitable process and is not limited to the specific processes described above. Also, while shown as a series of steps, various steps in FIG. 8 may overlap, occur in parallel, or occur any number of times.

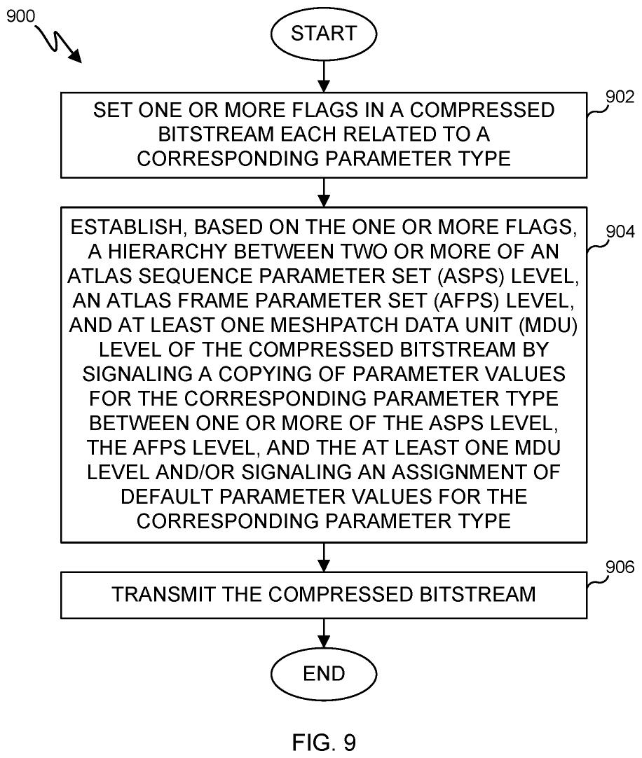

FIG. 9 illustrates an example encoding method 900 in accordance with this disclosure. For ease of explanation, the method 900 of FIG. 9 is described as being performed using the electronic device 300 of FIG. 3. However, the method 900 may be used with any other suitable system and any other suitable electronic device.

The method 900 can be performed as part of creating a compressed bitstream. At step 902, the electronic device 300, such as via a processor of the electronic device 300, sets one or more flags in a compressed bitstream each related to a corresponding parameter type. At step 904, the electronic device 300 establishes, based on the one or more flags, a hierarchy between two or more of an atlas sequence parameter set (ASPS) level, an atlas frame parameter set (AFPS) level, and at least one meshpatch data unit (MDU) level of the compressed bitstream by signaling a copying of parameter values for the corresponding parameter type between one or more of the ASPS level, the AFPS level, and the at least one MDU level and/or signaling an assignment of default parameter values for the corresponding parameter type.

In various embodiments, as described in this disclosure, the corresponding parameter type for each of the one or more flags include an inverse quantization offset parameter type, a lifting offset parameter type, or a directional lifting parameter type.

In various embodiments, as described in this disclosure, an MDU subdivision method flag at the at least one MDU level may be set to zero, to allow another apparatus receiving the compressed bitstream to, based on a determination that the MDU subdivision method flag is set to zero, copy subdivision method data for a patch subdivision method parameter from the AFPS level when a subdivision count at the at least one MDU level is less than or equal to a subdivision count at the AFPS level, or use a default value for the patch subdivision method parameter.

In various embodiments, as described in this disclosure, it may be signalled in the compressed bitstream to initialize a patch subdivision method parameter to a value of zero, and if an MDU subdivision method flag at the at least one MDU level is set to zero, signal assigning a different value to the patch subdivision method parameter.

In various embodiments, as described in this disclosure, the one or more flags can include an atlas sequence parameter presence flag at the ASPS level, and it can be signaled to determine, based on the one or more flags, parameters for the corresponding parameter type of each of the one or more flags according to the established hierarchy, and, based on a determination that the atlas sequence parameter presence flag has a value equal to 1, retrieve syntax elements signaled at the ASPS level relating to the corresponding parameter type for the atlas sequence parameter presence flag.

In various embodiments, as described in this disclosure, the one or more flags can further includes an atlas frame parameter presence flag, and it can be signaled to another electronic device to determine, based on the one or more flags, parameters for the corresponding parameter type of each of the one or more flags according to the established hierarchy, and, when the atlas frame parameter presence flag has a value equal to 0, based on satisfying a condition comparing a subdivision count at the AFPS level with a subdivision count at the ASPS level, copy values for the corresponding parameter type for the atlas sequence parameter presence flag from corresponding ASPS level syntax elements, or assign the default parameter values for the corresponding parameter type for the atlas sequence parameter presence flag.

In various embodiments, as described in this disclosure, the one or more flags can include an MDU parameter enable flag at the at least one MDU level, and it can be signaled to another electronic device to determine, based on the one or more flags, parameters for the corresponding parameter type of each of the one or more flags according to the established hierarchy, and, when the MDU parameter enable flag has a value equal to 0, based on satisfying a condition comparing a subdivision count at the at least one MDU level with a subdivision count at the AFPS level, copy values for the corresponding parameter type for the MDU parameter enable flag from corresponding AFPS level syntax elements, or assign the default parameter values for the corresponding parameter type for the MDU parameter enable flag.

In various embodiments, as described in this disclosure, the one or more flags can include an MDU parameter enable flag at the at least one MDU level, and it can be signaled to another electronic device to determine, based on the one or more flags, parameters for the corresponding parameter type of each of the one or more flags according to the established hierarchy, and, when the MDU parameter enable flag has a value equal to 0, based on satisfying a condition comparing a subdivision count at the at least one MDU level with a subdivision count at the ASPS level, copy values for the corresponding parameter type for the MDU parameter enable flag from corresponding ASPS level syntax elements, or assign the default parameter values for the corresponding parameter type for the MDU parameter enable flag.

At step 906, the electronic device 300 transmits the compressed bitstream to another apparatus, such as by using a communication interface like the communication interface 220 or the TX processing circuitry 315/RF transceiver 310. In various embodiments, the output compressed bitstream can be transmitted to an external device or to a storage on the electronic device 300. In various embodiments, as described in this disclosure, the electronic device 300 may transmit the compressed bitstream without an atlas sequence inverse quantization offset presence flag at the ASPS level of the compressed bitstream, to cause another apparatus to infer that a value of the atlas sequence inverse quantization offset presence flag is zero, indicating that inverse quantization offset parameters are not present in the compressed bitstream.

Although FIG. 9 illustrates one example of an encoding method 900, various changes may be made to FIG. 9. For example, while shown as a series of steps, various steps in FIG. 9 may overlap, occur in parallel, or occur any number of times.

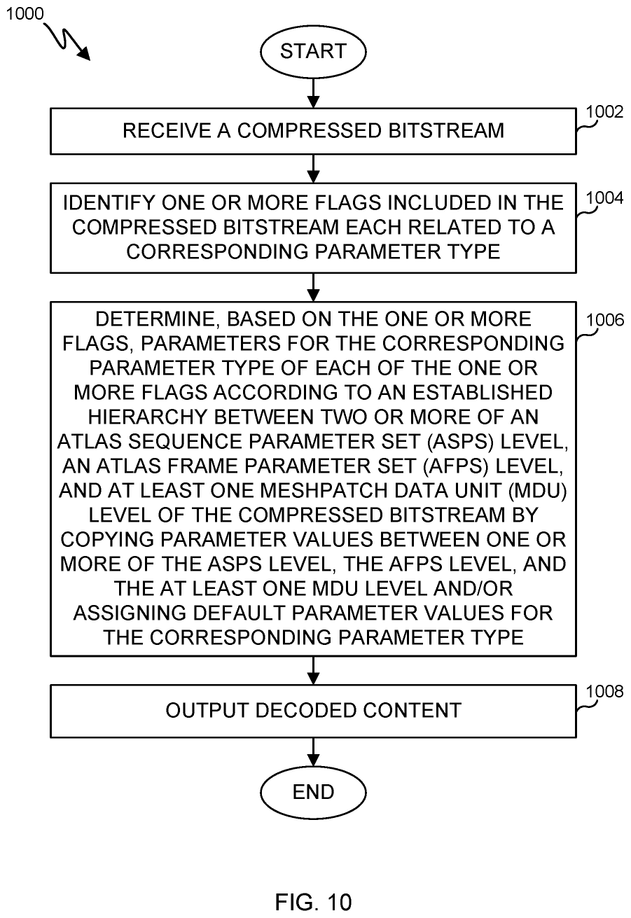

FIG. 10 illustrates an example decoding method 1000 in accordance with this disclosure. For ease of explanation, the method 1000 of FIG. 10 is described as being performed using the electronic device 300 of FIG. 3. However, the method 1000 may be used with any other suitable system and any other suitable electronic device.

As shown in FIG. 10, at step 1002, the electronic device 300 receives a compressed bitstream, such as via a communication interface like the communication interface 220 or the RX processing circuitry 325/RF transceiver 310. At step 1004, the electronic device 300 identifies one or more flags included in the compressed bitstream each related to a corresponding parameter type. At step 1006, the electronic device 300, such as using a processor of the electronic device 300, determines, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

In various embodiments, as described in this disclosure, the corresponding parameter type for each of the one or more flags may include an inverse quantization offset parameter type, a lifting offset parameter type, or a directional lifting parameter type. In various embodiments, as described in this disclosure, the electronic device 300 may also determine that an atlas sequence inverse quantization offset presence flag is not included at the ASPS level in the compressed bitstream, and, based on the determination that the atlas sequence inverse quantization offset presence flag is not included in the compressed bitstream, infer that a value of the atlas sequence inverse quantization offset presence flag is zero, indicating that inverse quantization offset parameters are not present in the compressed bitstream.

In various embodiments, as described in this disclosure, the electronic device 300 may determine that an MDU subdivision method flag at the at least one MDU level is set to zero, and, based on the determination that the MDU subdivision method flag is set to zero, copy subdivision method data for a patch subdivision method parameter from the AFPS level when a subdivision count at the at least one MDU level is less than or equal to a subdivision count at the AFPS level, or use a default value for the patch subdivision method parameter.

In various embodiments, as described in this disclosure, the electronic device may initialize a patch subdivision method parameter to a value of zero, determine that an MDU subdivision method flag at the at least one MDU level is set to zero, and, based on the determination that the MDU subdivision method flag is set to zero, assign a different value to the patch subdivision method parameter. In various embodiments, as described in this disclosure, the one or more flags can include an atlas sequence parameter presence flag at the ASPS level, and, to determine, based on the one or more flags, parameters for the corresponding parameter type of each of the one or more flags according to the established hierarchy, the electronic device 300 can, based on a determination that the atlas sequence parameter presence flag has a value equal to 1, retrieve syntax elements signaled at the ASPS level relating to the corresponding parameter type for the atlas sequence parameter presence flag.

In various embodiments, as described in this disclosure, the one or more flags can further include an atlas frame parameter presence flag, and, to determine, based on the one or more flags, parameters for the corresponding parameter type of each of the one or more flags according to the established hierarchy, the electronic device may, when the atlas frame parameter presence flag has a value equal to 0, based on satisfying a condition comparing a subdivision count at the AFPS level with a subdivision count at the ASPS level, copy values for the corresponding parameter type for the atlas sequence parameter presence flag from corresponding ASPS level syntax elements, or assign the default parameter values for the corresponding parameter type for the atlas sequence parameter presence flag.

In various embodiments, as described in this disclosure, the one or more flags can include an MDU parameter enable flag at the at least one MDU level, and, to determine, based on the one or more flags, parameters for the corresponding parameter type of each of the one or more flags according to the established hierarchy, the electronic device may, when the MDU parameter enable flag has a value equal to 0, based on satisfying a condition comparing a subdivision count at the at least one MDU level with a subdivision count at the AFPS level, copy values for the corresponding parameter type for the MDU parameter enable flag from corresponding AFPS level syntax elements, or assign the default parameter values for the corresponding parameter type for the MDU parameter enable flag.

In various embodiments, as described in this disclosure, the one or more flags can include an MDU parameter enable flag at the at least one MDU level, and, to determine, based on the one or more flags, parameters for the corresponding parameter type of each of the one or more flags according to the established hierarchy, the electronic device 300 may, when the MDU parameter enable flag has a value equal to 0, based on satisfying a condition comparing a subdivision count at the at least one MDU level with a subdivision count at the ASPS level, copy values for the corresponding parameter type for the MDU parameter enable flag from corresponding ASPS level syntax elements, or assign the default parameter values for the corresponding parameter type for the MDU parameter enable flag.

At step 1008, the electronic device outputs decoded content, which can include reconstructing volumetric data for rendering. In various embodiments, the electronic device 300 can output the decoded content using the reconstructed volumetric data, such as 3D video. The output decoded content can be transmitted to an external device, such as a display device, or to a storage device on the electronic device 300 or on another device, for example.

Although FIG. 10 illustrates one example of a decoding method 1000, various changes may be made to FIG. 10. For example, while shown as a series of steps, various steps in FIG. 10 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface configured to receive a compressed bitstream; and
a processor operably coupled to the communication interface, wherein the processor is configured to:
identify one or more flags included in the compressed bitstream each related to a corresponding parameter type; and
determine, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

2. The apparatus of claim 1, wherein the corresponding parameter type for each of the one or more flags include an inverse quantization offset parameter type, a lifting offset parameter type, or a directional lifting parameter type.

3. The apparatus of claim 1, wherein the processor is further configured to:
determine that an atlas sequence inverse quantization offset presence flag is not included at the ASPS level in the compressed bitstream; and
based on the determination that the atlas sequence inverse quantization offset presence flag is not included in the compressed bitstream, infer that a value of the atlas sequence inverse quantization offset presence flag is zero, indicating that inverse quantization offset parameters are not present in the compressed bitstream.

4. The apparatus of claim 1, wherein the processor is further configured to:
determine that an MDU subdivision method flag at the at least one MDU level is set to zero; and
based on the determination that the MDU subdivision method flag is set to zero:
copy subdivision method data for a patch subdivision method parameter from the AFPS level when a subdivision count at the at least one MDU level is less than or equal to a subdivision count at the AFPS level; or
use a default value for the patch subdivision method parameter.

5. The apparatus of claim 1, wherein the processor is further configured to:
initialize a patch subdivision method parameter to a value of zero;
determine that an MDU subdivision method flag at the at least one MDU level is set to zero; and
based on the determination that the MDU subdivision method flag is set to zero, assign a different value to the patch subdivision method parameter.

6. The apparatus of claim 1, wherein the one or more flags include an atlas sequence parameter presence flag at the ASPS level, and
wherein, to determine, based on the one or more flags, parameters for the corresponding parameter type of each of the one or more flags according to the established hierarchy, the processor is further configured to, based on a determination that the atlas sequence parameter presence flag has a value equal to 1, retrieve syntax elements signaled at the ASPS level relating to the corresponding parameter type for the atlas sequence parameter presence flag.

7. The apparatus of claim 6, wherein the one or more flags further includes an atlas frame parameter presence flag, and
wherein, to determine, based on the one or more flags, parameters for the corresponding parameter type of each of the one or more flags according to the established hierarchy, the processor is configured to, when the atlas frame parameter presence flag has a value equal to 0:
based on satisfying a condition comparing a subdivision count at the AFPS level with a subdivision count at the ASPS level, copy values for the corresponding parameter type for the atlas sequence parameter presence flag from corresponding ASPS level syntax elements; or
assign the default parameter values for the corresponding parameter type for the atlas sequence parameter presence flag.

8. The apparatus of claim 7, wherein the one or more flags include an MDU parameter enable flag at the at least one MDU level, and
wherein, to determine, based on the one or more flags, parameters for the corresponding parameter type of each of the one or more flags according to the established hierarchy, the processor is configured to, when the MDU parameter enable flag has a value equal to 0:
based on satisfying a condition comparing a subdivision count at the at least one MDU level with a subdivision count at the AFPS level, copy values for the corresponding parameter type for the MDU parameter enable flag from corresponding AFPS level syntax elements; or
assign the default parameter values for the corresponding parameter type for the MDU parameter enable flag.

9. The apparatus of claim 6, wherein the one or more flags include an MDU parameter enable flag at the at least one MDU level, and
wherein, to determine, based on the one or more flags, parameters for the corresponding parameter type of each of the one or more flags according to the established hierarchy, the processor is configured to, when the MDU parameter enable flag has a value equal to 0:
based on satisfying a condition comparing a subdivision count at the at least one MDU level with a subdivision count at the ASPS level, copy values for the corresponding parameter type for the MDU parameter enable flag from corresponding ASPS level syntax elements; or
assign the default parameter values for the corresponding parameter type for the MDU parameter enable flag.

10. A method comprising:
receiving a compressed bitstream;
identifying one or more flags included in the compressed bitstream each related to a corresponding parameter type; and
determining, based on the one or more flags, parameters for the corresponding parameter type of each of the one or more flags according to an established hierarchy between two or more of an atlas sequence parameter set (ASPS) level, an atlas frame parameter set (AFPS) level, and at least one meshpatch data unit (MDU) level of the compressed bitstream by copying parameter values between one or more of the ASPS level, the AFPS level, and the at least one MDU level and/or assigning default parameter values for the corresponding parameter type.

11. The method of claim 10, wherein the corresponding parameter type for each of the one or more flags include an inverse quantization offset parameter type, a lifting offset parameter type, or a directional lifting parameter type.

12. The method of claim 10, further comprising:
determining that an atlas sequence inverse quantization offset presence flag is not included at the ASPS level in the compressed bitstream; and
based on the determination that the atlas sequence inverse quantization offset presence flag is not included in the compressed bitstream, inferring that a value of the atlas sequence inverse quantization offset presence flag is zero, indicating that inverse quantization offset parameters are not present in the compressed bitstream.

13. The method of claim 10, further comprising:
determining that an MDU subdivision method flag at the at least one MDU level is set to zero; and
based on the determination that the MDU subdivision method flag is set to zero:
copying subdivision method data for a patch subdivision method parameter from the AFPS level when a subdivision count at the at least one MDU level is less than or equal to a subdivision count at the AFPS level; or
using a default value for the patch subdivision method parameter.

14. The method of claim 10, further comprising:
initializing a patch subdivision method parameter to a value of zero;
determining that an MDU subdivision method flag at the at least one MDU level is set to zero; and
based on the determination that the MDU subdivision method flag is set to zero, assigning a different value to the patch subdivision method parameter.

15. The method of claim 10, wherein the one or more flags include an atlas sequence parameter presence flag at the ASPS level, and
wherein, determining, based on the one or more flags, parameters for the corresponding parameter type of each of the one or more flags according to the established hierarchy includes, based on a determination that the atlas sequence parameter presence flag has a value equal to 1, retrieving syntax elements signaled at the ASPS level relating to the corresponding parameter type for the atlas sequence parameter presence flag.

16. The method of claim 15, wherein the one or more flags further includes an atlas frame parameter presence flag, and
wherein, determining, based on the one or more flags, parameters for the corresponding parameter type of each of the one or more flags according to the established hierarchy includes, when the atlas frame parameter presence flag has a value equal to 0:
based on satisfying a condition comparing a subdivision count at the AFPS level with a subdivision count at the ASPS level, copying values for the corresponding parameter type for the atlas sequence parameter presence flag from corresponding ASPS level syntax elements; or
assigning the default parameter values for the corresponding parameter type for the atlas sequence parameter presence flag.

17. The method of claim 16, wherein the one or more flags include an MDU parameter enable flag at the at least one MDU level, and
wherein, determining, based on the one or more flags, parameters for the corresponding parameter type of each of the one or more flags according to the established hierarchy includes, when the MDU parameter enable flag has a value equal to 0:
based on satisfying a condition comparing a subdivision count at the at least one MDU level with a subdivision count at the AFPS level, copying values for the corresponding parameter type for the MDU parameter enable flag from corresponding AFPS level syntax elements; or
assigning the default parameter values for the corresponding parameter type for the MDU parameter enable flag.

18. The method of claim 15, wherein the one or more flags include an MDU parameter enable flag at the at least one MDU level, and
wherein, determining, based on the one or more flags, parameters for the corresponding parameter type of each of the one or more flags according to the established hierarchy includes, when the MDU parameter enable flag has a value equal to 0:
based on satisfying a condition comparing a subdivision count at the at least one MDU level with a subdivision count at the ASPS level, copying values for the corresponding parameter type for the MDU parameter enable flag from corresponding ASPS level syntax elements; or
assigning the default parameter values for the corresponding parameter type for the MDU parameter enable flag.

19. An apparatus comprising:
a communication interface; and
a processor operably coupled to the communication interface, the processor configured to:
set one or more flags in a compressed bitstream each related to a corresponding parameter type;
establish, based on the one or more flags, a hierarchy between two or more of an atlas sequence parameter set (ASPS) level, an atlas frame parameter set (AFPS) level, and at least one meshpatch data unit (MDU) level of the compressed bitstream by signaling a copying of parameter values for the corresponding parameter type between one or more of the ASPS level, the AFPS level, and the at least one MDU level and/or signaling an assignment of default parameter values for the corresponding parameter type; and
transmit the compressed bitstream using the communication interface.

20. The apparatus of claim 1, wherein the processor is further configured to:
transmit the compressed bitstream without an atlas sequence inverse quantization offset presence flag at the ASPS level of the compressed bitstream, to cause another apparatus to infer that a value of the atlas sequence inverse quantization offset presence flag is zero, indicating that inverse quantization offset parameters are not present in the compressed bitstream.
